(19) United States
(12) Patent Application Publication
(10) Pub. No.: US 2006/0255606 A1
(43) Pub. Date: Nov. 16, 2006

(54) Spatula

(76) Inventors: Sharon K. Lemon, Canton, OH (US); Allen J. Lemon, Canton, OH (US)

Correspondence Address: FRED ZOLLINGER III, P.O. BOX 2368, NORTH CANTON, OH, 44720, US

(21) Appl. No.: 11/433,076

(22) Filed: May 12, 2006

Related U.S. Application Data
(60) Provisional application No. 60/680,343, filed on May 12, 2005.

(51) Int. Cl. A47J 43/28

(52) U.S. Cl. 294/8

(57) ABSTRACT

A spatula includes a handle that carries a power source and a motor or solenoid that drives a tool end between ready and flipped positions upon the activation of a switch. The spatula may be configured to automatically return to the ready position. The spatula may thus be used to flip pancakes, burgers, and the like by someone with an injured wrist or elbow.

### CROSS REFERENCE TO RELATED APPLICATIONS

This application claims priority from U.S. Provisional Patent application Ser. No. 60/680,343 filed May 12, 2005; the disclosure of which are incorporated herein by reference.

### BACKGROUND OF THE INVENTION

1. Technical Field

The present invention generally relates to kitchen tools and, more particularly, a spatula or flipper having a switch that allows the end of the spatula to be automatically rotated when the switch is activated. Specifically, the invention relates to a powered tool that automatically rotates the end of the tool upon activation of a switch. The invention also relates to such kitchen implements that have interchangeable components.

2. Background Information

Those with carpal tunnel syndrome may have significant difficulties utilizing typical kitchen tools such as those that require elbow and wrist action during use. One such tool is a turner or spatula used to flip burgers pancakes, and the like. Those with such pain desire a tool that automatically actuates. The tool should also be adjustable for a wide variety of users.

### BRIEF SUMMARY OF THE INVENTION

The invention provides a spatula that automatically rotates in response to an input signal. Different powered and un-powered configurations are provided. In the powered configurations, a motor or solenoid is used to drive the kitchen tool end between the ready and flipped positions. In the un-powered configurations, power from the user is used to flip the tool end with springs used to return the tool end to the ready position. The power from the user is converted to the rotary movement with levers, gears, racks, or pulleys or a combination of these elements.

In one configuration, the invention provides a powered spatula having a handle; a drive carried by the handle; the drive being connected to the flexible drive arm; the drive adapted to rotate the flexible drive arm in at least one direction; a flexible drive arm extending from the handle; and a kitchen tool end connected to the flexible drive arm.

In another configuration, a bi-stable solenoid is used to rotate the tool end. The solenoid automatically returns to its ready position after it has turned the tool end. This configuration allows the user to activate the spatula with a single press of a switch.

In any of these powered configurations, the spatula may be configured to locate the tool end in a position offset from the handle. In any of these configurations, the spatula may include a flexible neck.

### BRIEF DESCRIPTION OF THE SEVERAL VIEWS OF THE DRAWINGS

FIGS. 1A-1E depict a first configuration of the automatic spatula of the invention using an electric motor to activate the flipping action.

FIGS. 2A-2C depict a second configuration of the automatic spatula of the invention using a pulley-style actuator.

FIGS. 3A-3D depict a third configuration of the automatic spatula showing a lever actuator.

FIGS. 4A-4D depict a fourth configuration of the automatic spatula showing a rack and pinion actuator.

FIGS. 5A-5C depict a fifth configuration of the invention showing a motorized, adjustable tool.

FIGS. 6A-6B depict the exterior of the handle of the fifth configuration.

FIG. 7 is a schematic of the electrical system of the fifth configuration of the invention.

FIGS. 8A-8C depict a sixth configuration of the spatula.

FIG. 9 depicts a different tool end that may be connected to any of the configurations described below.

### DETAILED DESCRIPTION OF THE INVENTION

Each of the configurations of the invention described below and in the series of drawings forming part of the specification includes a handle and an input device that allows a kitchen tool end to be selectively rotated upon the activation of the input. The inputs include switches as shown in the first, fifth, and sixth configurations and pivoting triggers as shown in the second, third, and fourth configurations. The kitchen tool ends may be a variety of spatula devices, flippers, turners, spoons, knives, and other known kitchen tools.

In each of the configurations, the kitchen tool end may be removed from the handle and replaced with a different end. The different end may be a different type of tool, a different sized tool, or the same tool fabricated from a different material. In each of the configurations, the kitchen tool end may also be integrally attached to the handle with the output shaft of the device.

1. Electric Motor—Gears

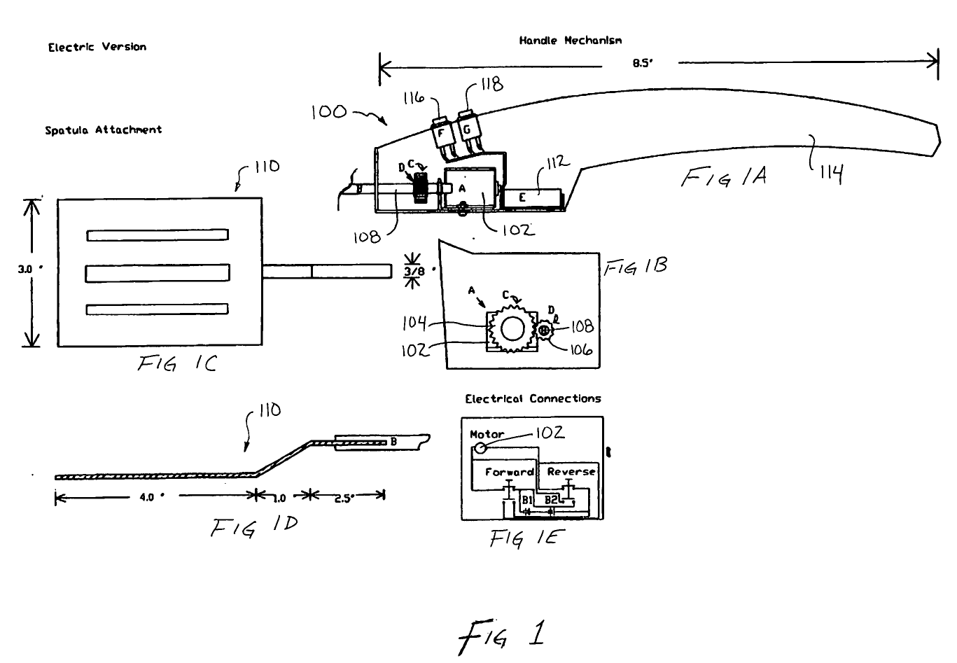

The first configuration of the spatula is indicated generally by the numeral 100 in FIGS. 1A-1E. Spatula 100 includes an electric motor 102 having a large output gear 104 that meshingly engages a small drive gear 106. Drive gear 106 is connected to the output shaft 108 that supports the kitchen tool end 110. Kitchen tool end 110 in this configuration is a metal or plastic spatula end. Spatula 100 further includes a battery 112 carried inside a handle 114. Switches 116 and 118 are also carried by handle 114. Switches 116 and 118 selectively cause an electric current to flow through motor 102 in different directions to rotate shaft 108 in different directions. The first configuration of spatula 100 allows shaft 108 to rotate 360° with respect to handle 114. A variety of different gear ratios may be used depending on the size of the motor and the size of the kitchen tool end. In the configuration shown in the drawing, the ratio is 2 to 1.

2. Pulley Version

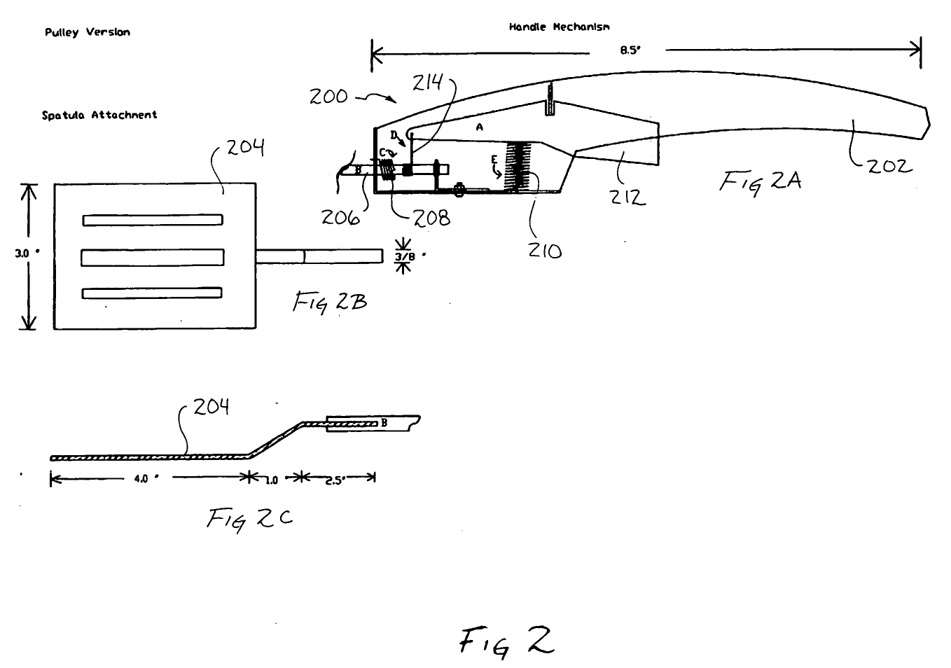

The second configuration of the spatula is indicated generally by the numeral 200 in FIGS. 2A-2C. In this configuration, spatula generally includes a handle 202 that supports a kitchen tool end 204. Tool end 204 is connected to an output shaft 206 that is biased with a spring 208 toward a rotated position that places tool end 204 in a vertical or flipped-over position. Shaft 206 is held in a ready position by a trigger spring 210 that urges a pivotable trigger 212 to a ready position. The end of trigger 212 is connected to shaft 206 with a cable 214 that is wrapped around a portion of shaft 206 like a pulley. Activation of a pivoting trigger 212 causes spring 210 to compress which allows the cable 214 to loosen thus allowing spring 208 to cause shaft 206 to rotate. When the force on trigger 212 is removed, spring 210 forces the end of the lever upwardly to rotate shaft 206 back to the ready position with cable 214.

3. Lever Version

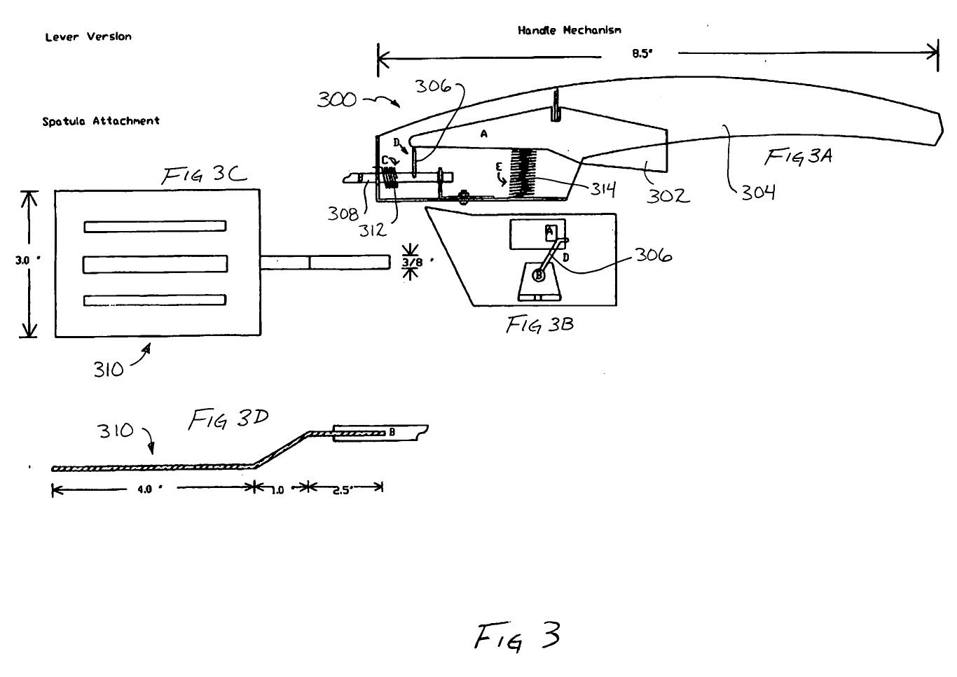

The third configuration of the spatula is indicated generally by the numeral 300 in FIGS. 3A-3D. In this configuration, a trigger 302 that pivots with respect to a handle 304 pushes down on a lever 306 (fixed to shaft 308) to rotate the output shaft 308 and thus the kitchen tool end 310. Shaft 308 may be configured rotate 1000 about its longitudinal axis. Return springs 312 and 314 are used to return tool end 310 to its ready position.

4. Rack and Pinion Version

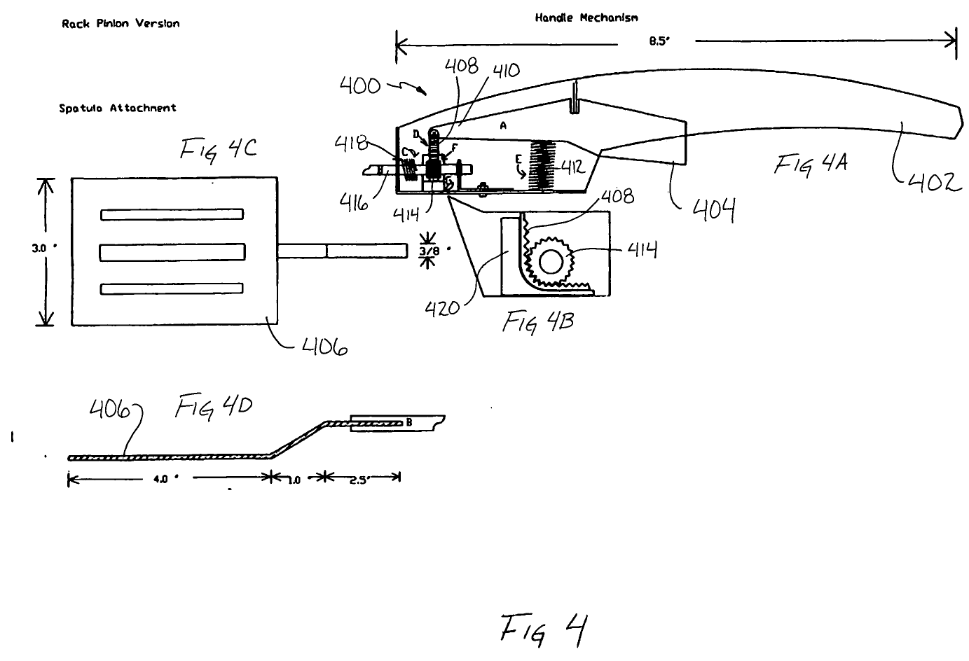

The fourth configuration of the spatula is indicated generally by the numeral 400 in FIGS. 4A-4D. Spatula 400 generally includes a handle 402 having a trigger 404 that activates a kitchen tool end 406 between ready and activated positions. In this configuration, a rack 408 is connected to the outer end 410 of pivoting trigger 404. A return spring 412 is used to return trigger 404 to its ready position. A pinion gear 414 meshingly engages rack 408 to activate the rotation of an output shaft 416. A secondary return spring 418 may be used to help return shaft 416 to its ready position. A block 420 supports the sliding rack 408 to maintain the meshed connection between the gear teeth. Spatula 400 may be configured to rotate end 406 190°.

5. Electric Motor—Flexible Drive Shaft

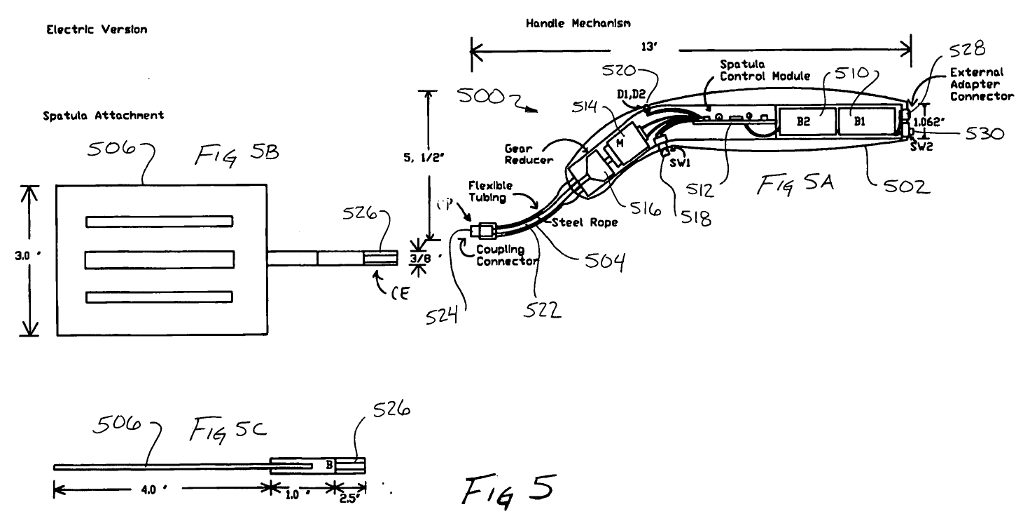

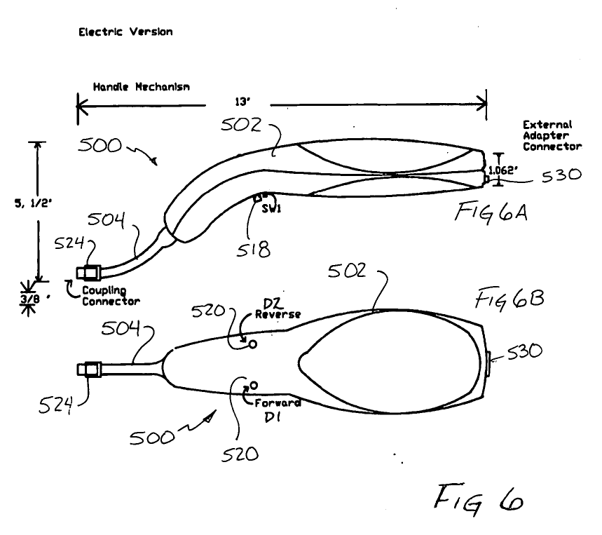

The fifth configuration of the spatula is indicated generally by the numeral 500 in FIGS. 5-7. Spatula 500 generally includes a handle 502, an elongated neck 504, and a kitchen tool end 506. Handle 502 is adapted to fit comfortably in the user's hand in a substantially horizontal orientation with the front portion of handle 502 and neck 504 defining an “S” that places end 506 in a horizontal configuration at a position lower than handle 502 as shown in FIG. 5. Handle 502 defines a chamber that carries most of the components of spatula 500. Handle 502 may be configured to be water-tight to allow it to be washed and used in a kitchen environment while protecting the components inside handle 502. The arrangement of the components within the handle chamber balances spatula 500. Handle 502 carries the power supply 510 (two batteries), a control module 512, a motor 514, a transmission 516, an input switch 518, and indicator lights 520. Handle 502 may be configured to have a separate chamber for the batteries 510.

The front end of handle 502 may be tilted downwardly with respect to the middle and rear ends. For example, the front end may be tilted down about 25-50 degrees from horizontal with neck 504 being bent back an opposite amount so that the end of neck 504 is also horizontal. This provides an offset tool handle and a comfortable configuration for the user. Neck 504 may be flexible so that the angle of tool end 506 may be adjusted.

Tool end 506 is connected to the output of transmission 516 with a flexible drive 522 which may be a section of steel rope.

A coupler 524 is adapted to receive any of a variety of kitchen tool ends 506 formed with a mating coupler end 526. Coupler 524 may define a non-circular recess such as the depicted hexagonal coupler that receives a mating end 526. A biased detent may be used to secure tool end 506 in place. Other couplers may also be used such as those with biased, cantilevered locking fingers, screw threads, or snap fits. The kitchen tool ends may be flippers, spatulas, mixer heads, forks, or spoons.

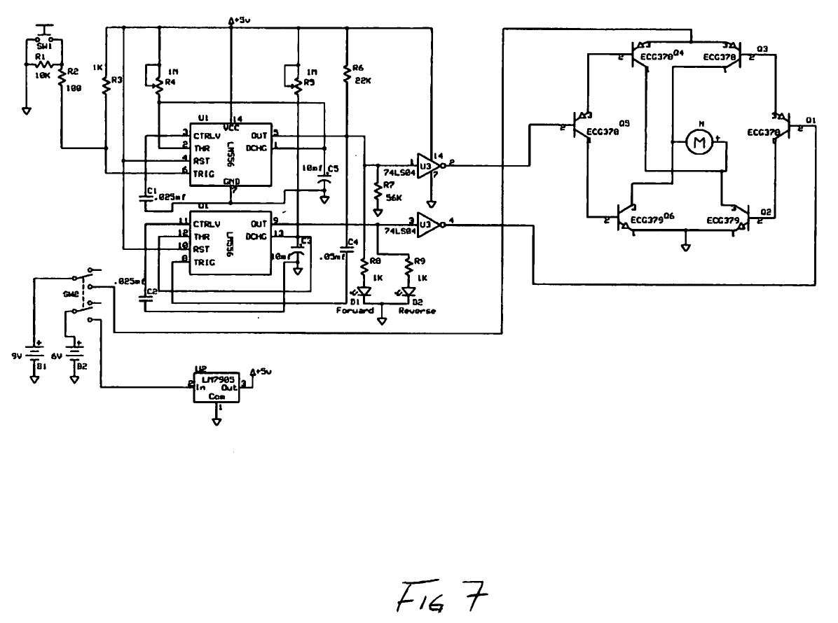

As shown in FIGS. 5 and 7, power source 510 is electrically connected to control module 512. In the exemplary embodiment, control module 512 includes a pair of LM556 circuits from National Semiconductor. Control module 512 receives an input signal from switch 518 to activate the tool. Once an input signal is received, control module 512 sends an output signal to motor 514 causing it to rotate drive 522 through an optional transmission (that may be a gear reducer) 516. Motor 514 is controlled by timing. Control module 512 may be configured to automatically: (1) rotate the tool end until the user presses the switch again or until the user releases the switch; (2) rotate the drive arm 360 degrees and then stop; or (3) rotate the drive arm through a fixed rotation and then back again to its initial position (such as rotating 170 degrees and then back to its initial position). In the exemplary configuration of control module 512 is disclosed in FIG. 7, spatula 500 is configured to automatically flip over and return to its initial position with a push of a single button. This configuration is especially useful for those with sore hands or elbows.

In alternative configurations, control module 512 may use forward and reverse switches to control the movement of tool end 506. The movement may also be controlled with a position sensor instead of a timer.

Indicator lights 520 optionally may be used to show the user the status of motor 514. Lights 520 are visible to the user from the top of tool 500. One light is used to show the forward direction of motor 514 and the other light is used to show the reverse direction of motor 514.

An external power adapter (or battery charger) 528 optionally may be provided at the rear end of the handle. A cord may be fit into the adapter to plug the tool into a wall outlet.

A power switch 530 may also be provided. The power switch may be used to turn the tool on and off.

6. Electric Motor—Solenoid

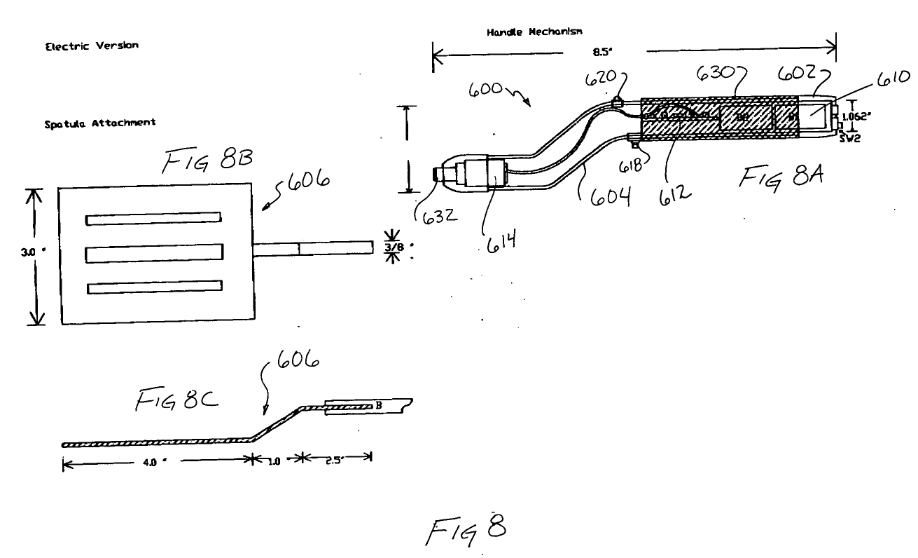

The sixth configuration of the spatula is indicated generally by the numeral 600 in FIGS. 8A-8C. Spatula 600 generally includes a handle 602 having an offset neck 604 and a kitchen tool end 606. Handle 602 is adapted to fit comfortably in the user's hand in a substantially horizontal orientation with neck 604 defining an “S” that places end 606 in a horizontal configuration at a position lower than the rear portion of handle 602 as shown in FIG. 8.

Handle 602 defines a chamber that carries most of the components of spatula 600. Handle 602 may be configured to be water-tight to allow it to be washed and used in a kitchen environment while protecting the components inside handle 602. The arrangement of the components within the handle chamber balances spatula 600. Handle 602 carries the power supply 610 (two batteries), a control module 612, a solenoid 614, an input switch 618, and at least one indicator light 620. Handle 602 may be configured to have a separate chamber for the batteries 610. Batteries 610 and solenoid 614 are disposed at opposite ends of handle 602 to balance spatula 600.

Spatula 600 is adapted to rotate tool end 606 from a ready position to a rotated position and back to the ready position upon the activation of switch 618. Activation of switch 618 sends a signal to control module 612 which powers solenoid 614 causing end 606 to rotate in a first direction and then back to its ready position. Solenoid 614 may be a bi-stable solenoid configured to automatically move in the desired manner upon receiving an actuation signal. This configuration allows the user to operate spatula 600 by pushing switch 618 once. Light 620 may be used to indicate the operation of solenoid 614, the direction of rotation, or simply if the power is on.

A soft rubber or textured grip 630 may be provided on the outside of a portion of handle 602.

End 606 may be connected to the output 632 of solenoid 614 be any of the manners described above.

This configuration may be combined with the fifth configuration wherein the motor 514 may be positioned at the location of solenoid 614.

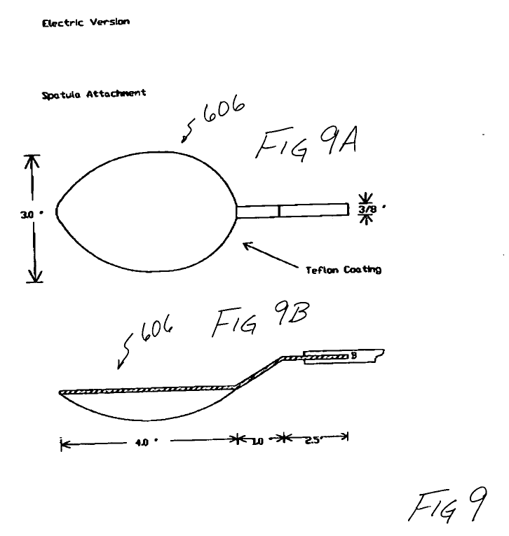

FIG. 9 depicts an alternative end 606 that may be used with any of the configurations described in this application.

The elements of the configurations described above may be interchanged to create further configurations. For example, the flexible neck of the fifth configuration may be used with any of the other configurations to provide the benefits of the flexible neck. In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described.

1. A kitchen tool comprising:
a handle;
a motor carried by the handle;
the motor having an output;
the output of the motor being connected to a transmission;
the transmission having an output;
the output of the transmission being connected to a flexible drive arm; and
a kitchen tool end being connected to the flexible drive arm.

2. The tool of claim 1, wherein the kitchen tool end is removably connected to the flexible drive arm.

3. The tool of claim 1, further comprising an input switch adapted to control the actuation of the motor.

4. The tool of claim 1, further comprising a section of flexible tubing connected to the handle; a portion of the flexible drive arm being disposed in the section of flexible tubing.

5. The tool of claim 1, further comprising a pair of lights carried by the handle; the lights indicating the direction of rotation for the kitchen tool end.

6. The tool of claim 1, further comprising a power input carried by the handle.

7. The tool of claim 1, wherein the handle has a front end that is tilted down.

8. A kitchen tool comprising:
a handle;
a power source;
a solenoid carried by the handle; the solenoid being electrically connected to the power source;
the solenoid having an output; and
the output of the motor being connected to a kitchen tool end.

9. The tool of claim 8, further comprising a switch operable to activate the solenoid to move from a ready position to a rotated position and back to a ready position.

10. The tool of claim 9, wherein the solenoid is a bi-stable solenoid.

11. The tool of claim 10, wherein the handle includes an S-shaped portion to offset the kitchen tool end.

12. The tool of claim 8, further comprising an indicated light carried by the handle.

13. A kitchen tool comprising:
a handle;
a drive carried by the handle; the drive being connected to the flexible drive arm; the drive adapted to rotate the flexible drive arm in at least one direction;
a flexible drive arm extending from the handle; and
a kitchen tool end connected to the flexible drive arm.

14. The kitchen tool of claim 13, wherein the flexible drive arm is disposed in a tube; the tube being non-rotatably supported with respect to the handle.

15. The kitchen tool of claim 13, wherein the drive includes an electric motor.
